(19) United States
(12) Patent Application Publication
(10) Pub. No.: US 2013/0088396 A1
(43) Pub. Date: Apr. 11, 2013

(54) BANDWIDTH ADJUSTABLE DIELECTRIC RESONANT ANTENNA

(71) Applicant: Myeong Woo HAN, Gyunggi-do (KR)

(72) Inventor: Myeong Woo HAN, Gyunggi-do (KR)

(73) Assignee: SAMSUNG ELECTRO-MECHANICS CO., LTD., Gyunggi-do (KR)

(21) Appl. No.: 13/326,921

(22) Filed: Dec. 15, 2011

(30) Foreign Application Priority Data
Oct. 5, 2011 (KR) 10-2011-0101429

(51) Int. Cl. H01Q 9/04

(52) U.S. Cl. 343/700 MS

(57) ABSTRACT

Disclosed herein is a bandwidth adjustable dielectric resonant antenna. The dielectric resonator antenna includes: a multi-layer substrate; a first conductor plate formed on a top portion of an uppermost insulating layer to have an opening part; a second conductor plate formed on a bottom portion of a lowermost insulating layer; a plurality of metal vial holes penetrating through a circumference of the opening part of the first conductor plate at a predetermined interval; a feeding unit supplying power to the dielectric resonator embedded in the multi-layer substrate in the cavity shape by the first conductor plate, the second to conductor plate, and the plurality of metal via holes; and at least one multi-resonant generation via holes formed within the dielectric resonator so as to adjust the bandwidth by generating the multi-resonance within the dielectric resonator, thereby improving the bandwidth without increasing the size of the dielectric resonator and implementing miniaturization.

### CROSS REFERENCE TO RELATED APPLICATION

This application claims the benefit of Korean Patent Application No. 10-2011-0101429, filed on Oct. 5, 2011, entitled “Bandwidth Adjustable Dielectric Resonant Antenna,” which is hereby incorporated by reference in its entirety into this application.

### BACKGROUND OF THE INVENTION

1. Technical Field

The present invention relates to a bandwidth adjustable dielectric resonant antenna.

2. Description of the Related Art

As the existing transmitting and receiving system, a system configured by assembling individual parts has been mainly used. However, research into a system on package (SOP) product in which a transmitting and receiving system in a millimeter-wave band is configured by a single package has been conducted. Some products thereof have been commercialized.

A technology of a single package product has been developed with the development of multi-layer substrate process technologies of multilayering a dielectric substrate such as low temperature co-fired ceramic (LTCC), liquid crystal polymer (LCP), or the like.

Recently, research into a local wireless communication transceiver for transmitting large-capacity data such as the next-generation WiFi of 2.4 GHz/5GHz and WPAN of 60 Hz has been actively conducted inside and outside the country

In particular, the 60 GHz band can use a wide bandwidth of several GHz without a license and therefore, has been greatly interested in applying for a large-capacity transmission system that can wirelessly transmit at high speed large-capacity data and full HD images between smart devices providing a simple voice services and image and data services.

Therefore, for the local wireless communication application in the 60 GHz band, a wideband frequency of 7 GHz or more is used and an operating frequency of the used antenna also demands wideband characteristics accordingly.

In order to satisfy the demand of the wideband characteristics, the dielectric resonant antenna manufactured under the multi-layer substrate environment according to the prior art has been used, which has a small change in characteristics due to a process error as compared with a free-standing antenna such as a monopole antenna, a horn antenna, or the like.

However, when the process error of about ±10% occurs in an actual manufacturing process, a resonant point may be shifted by about ±1 to 2 GHz based on the 60 GHz band. Therefore, it is necessary to secure a design margin in consideration of the process error.

In order to solve the problem, the dielectric resonant antenna according to the prior art needs to increase a size of a cavity type dielectric resonant embedded in a multi-layer substrate so as to improve a bandwidth, which has resulted in increasing the entire size of the antenna.

### SUMMARY OF THE INVENTION

The present invention has been made in an effort to provide a bandwidth adjustable dielectric resonant antenna capable of adjusting a bandwidth by generating multi-resonance by forming multi-resonant generation via holes within a dielectric resonant antenna embedded in a multi-layer substrate.

According to a preferred embodiment of the present invention, there is provided a bandwidth adjustable dielectric resonant antenna, including: a multi-layer substrate on which a plurality of insulating layers are multilayered; a first conductor plate formed on a top portion of an uppermost insulating layer of the multi-layer substrate to have an opening part thereon; a second conductor plate formed on a bottom portion of a lowermost insulating layer of the multi-layer substrate to correspond to the opening part; a plurality of first metal via holes electrically connecting between respective layers of the multi-layer substrate multilayered between the first and second conductor plates and vertically penetrating through the multi-layer substrate so as to form a vertical metal interface while surrounding a circumference of the opening part of the first conductor plate at a predetermined interval; a feeding unit including a feeding line supplying power to the dielectric resonator embedded in the multi-layer substrate in the cavity shape by the metal interface formed by the first conductor plate, the second conductor plate, and the plurality of first metal via holes; and at least one multi-resonant generation via holes formed within the dielectric resonator by vertically penetrating through the multi-layer substrate so as to adjust the bandwidth by generating the multi-to resonance within the dielectric resonator.

The dielectric resonator may be formed to have a hexahedral shape.

The insulating layer may be a low temperature co-fired ceramic (LTCC) dielectric or an organic dielectric.

The organic dielectric may be FR4.

A distance between at least one multi-resonant generation via hole and the feeding line may be λ/4, where λ is a frequency wavelength within the dielectric resonator.

At least one multi-resonant generation via hole may be grounded with the second conductor plate.

As the number of at least one multi-resonant generation via hole increases, the bandwidth may be improved correspondingly.

As the length of at least one multi-resonant generation via hole becomes short, the bandwidth may be improved correspondingly.

As the position of at least one multi-resonant generation via hole is symmetrical based on the feeding line, the bandwidth may be improved correspondingly.

The feeding unit may include: a feeding line formed of the conductor plate in a line shape that extends so as to be inserted into the dielectric resonator from one surface of the dielectric resonator, with being horizontal with the opening part of the dielectric resonator; a first ground plate disposed so as to correspond to the feeding line and formed on any one of the same layer as the layer formed with the feeding line and the top portion of the insulating layer multilayered above at least one layer or more from the feeding line; and a second ground plate disposed to correspond to the feeding line and formed on the bottom portion of the insulating layer multilayered below at least one layer or more from the feeding line.

The feeding unit may further include a plurality of second metal via holes vertically penetrating through the multi-layer substrate so as to connect between the first conductor plate and the second ground plate by forming the vertical metal interface along the feeding line.

The feeding line may be formed between the top portion of the uppermost insulating layer and the top portion of the lowermost insulating layer.

The feeding line may be any one of a strip line, a micro strip line, and a coplanar waveguide (CPW) line.

The first ground plate may be formed to be integrated with the first conductor plate.

### BRIEF DESCRIPTION OF THE DRAWINGS

FIG. 1A is a perspective view of a bandwidth adjustable dielectric resonant antenna according to a preferred embodiment of the present invention;

FIG. 1B is a top view of the dielectric resonant antenna of FIG. 1A;

FIG. 1C is a cross-sectional view of the dielectric resonant antenna taken along line A-A′ shown in FIG. 1A;

FIGS. 2A to 2F are diagrams showing multi-resonant generation via holes variously formed according to the preferred embodiment of the present invention;

FIGS. 3A to 3C are diagrams for describing multi-resonant generation characteristics according to a ground or open state of multi-resonant generation via holes according to the preferred embodiment of the present invention;

FIG. 4 is a diagram for describing multi-resonant generation characteristics according to presence and absence of the multi-resonant generation via holes according to the preferred embodiment of the present invention;

FIGS. 5A to 5C are diagrams for describing the multi-resonant generation characteristics according to the number of multi-resonant generation via holes according to the preferred embodiment of the present invention;

FIGS. 6A to 6D are diagrams for describing the multi-resonant generation characteristics according to a length of the multi-resonant generation via hole according to the preferred embodiment of the present invention; and

FIGS. 7A to 7C are diagrams for describing the multi-resonant generation to characteristics according to a position of the multi-resonant generation via hole according to the embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

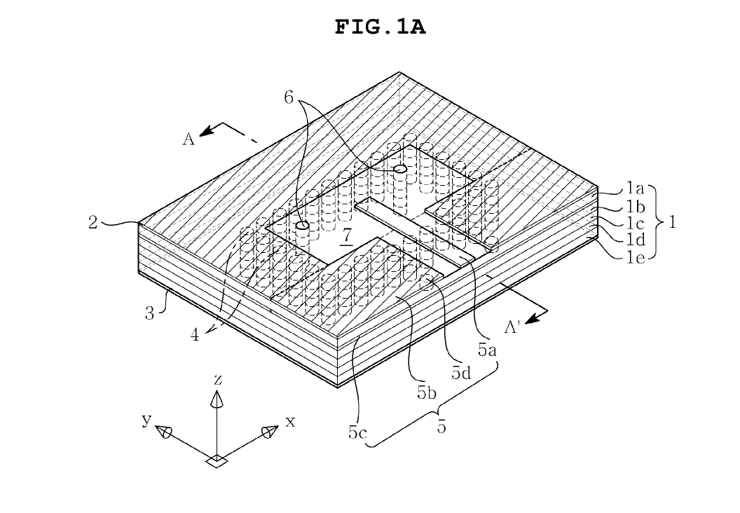

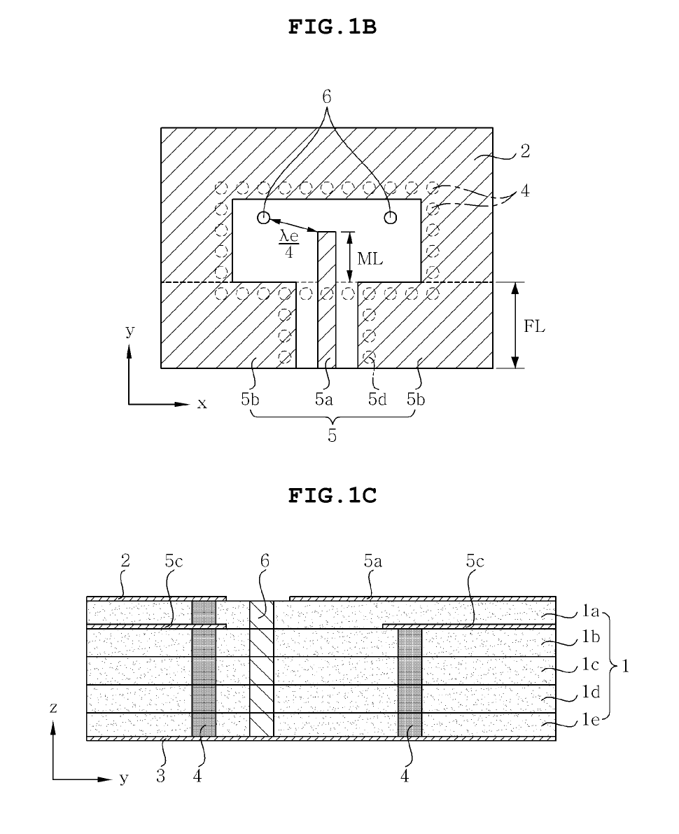

FIG. 1A is a perspective view of a bandwidth adjustable dielectric resonant antenna according to a preferred embodiment of the present invention, FIG. 1B is a top view of the dielectric resonant antenna of FIG. 1A, and FIG. 1C is a cross-sectional view of the dielectric resonant antenna taken along line A-A′ shown in FIG. 1A.

Referring to FIGS. 1A to 1C, a bandwidth adjustable dielectric resonant antenna to according to a preferred embodiment of the present invention is configured to include a multi-layer substrate 1, a first conductor plate 2, a second conductor plate 3, a plurality of first metal via holes 4, a feeding unit 5 including a feeding line 5a, and multi-resonant generation via holes 6.

The multi-layer substrate 1 is a substrate on which a plurality of insulating layers 1a to 1e are multilayered.

In this configuration, as the insulating layers 1a to 1e, a low temperature co-fired ceramic (LTCC) or an organic dielectric such as FR may be used.

The first conductor plate 2 is formed on a top portion of an uppermost insulating layer 1a of the multi-layer substrate to have an opening part thereon.

In this case, the opening part may be formed in various shapes such as a polygon, a circle, an oval, or the like, including a rectangle.

The second conductor plate 3 is formed on a bottom portion of a lowermost insulating layer 1e of the multi-layer substrate to correspond to the opening part.

The first and second conductor plates 2 and 3 as described above perform both of a role as a metal interface defining a dielectric resonator 7 and a role as a ground plate of the feeding unit 5 to be described below.

The plurality of first metal vial holes 4 electrically connect between respective layers of the multi-layer substrate 1 multilayered between the first and second conductor plates 2 and 3 and are formed by vertically penetrating through the multi-layer substrate 1 so as to form a vertical metal interface while surrounding the circumference of the opening part of the first conductor plate 2 at a predetermined interval.

As described above, the multi-layer substrate 1 is formed with the first conductor plate 2, the second conductor plate 3, and the plurality of first metal via holes 4. In this case, the dielectric resonator 7 maintaining a resonant mode by the metal interface formed by the above components may be embedded in the multi-layer substrate 1.

In the ideal case, the multi-layer substrate 1 demands the vertical metal interface, to which is difficult to manufacture. This may be replaced using the plurality of first metal via holes 4 arranged at a predetermined interval.

The feeding unit 5 is formed on one side of the dielectric resonator 7 so as to supply power to the dielectric resonator 7 embedded in the multi-layer substrate 1 in a cavity shape.

The feeding unit 5 is implemented to feed electricity by using a strip line, a transmission line such as a micro strip line and a coplanar waveguide (CPW) line, that is, the feeding line 5a, that may be easily formed on the multi-layer substrate 1.

In more detail, the feeding unit 5 is configured by one feeding line 5a, a first ground plate 5b, and a second ground plate 5c.

The feeding line 5a is formed of a conductor plate in a line shape that extends so as to be inserted into the dielectric resonator 7 from one surface of the dielectric resonator 7, with being horizontal with the opening part of the dielectric resonator 7.

In this case, the feeding line 5a may be disposed at any place from the top portion of the uppermost insulating layer 1a of the multi-layer substrate 1 to the top portion of the lowermost insulating layer 1e of the multi-layer substrate.

The first ground plate 5b is disposed so as to correspond to the feeding line 5a and is formed on any one of the same layer as the layer formed with the feeding line 5a and the top portion of the insulating layer multilayered above at least one layer or more from the feeding line 5a.

The second ground plate 5c is disposed to correspond to the feeding line 5a and formed on the bottom portion of the insulating layer multilayered below at least one layer or more from the feeding line 5a.

For example, as shown in FIGS. 1A to 1C, when the feeding line 5a is formed on the top portion of the uppermost insulating layer 1a of the multi-layer substrate 1, the first ground plate 5b may be formed on the same layer (that is, the top portion of the uppermost insulating layer 1a) as the layer on which the feeding line 5a is formed.

When the feeding line 5a is formed between the second insulating layer 1b and the third insulating layer 1c, the first ground plate 5b may be disposed on the top portion of the insulating layer (for example, the second insulating layer lb) multilayered above at least one layer or more from the feeding line 5a so as to correspond to the feeding line 5a and the second ground plate 5c may be disposed on the bottom portion of the insulating layer (for example, the third insulating layer 1c or the fourth insulating layer 1d) multilayered below at least one layer or more from the feeding line 5a so as to correspond to the feeding line 5a.

In this case, the first and second ground plates 5b and 5c need to be disposed to correspond to the feeding line 5a and the size and shape therefore is not limited.

Therefore, as shown in FIGS. 1a to 1c, the first ground plate 5b needs only some regions 5b corresponding to a position corresponding to the feeding line 5a in at least a region partitioned by a dotted line but may be replaced with the first conductor plate 2 including the region 5b.

That is, the first ground plate 5b may be integrally with the first conductor plate 2.

Similarly, as shown in FIGS. 1a to 1c, the second ground plate 5c also needs only some regions corresponding to a position corresponding to the feeding line 5a in at least a region partitioned by a dotted line but may use the conductor plate having the same size and shape as the first conductor plate 2 including the region.

In addition, the feeding unit 5 is applied with a high frequency signal through the feeding line 5a and serves as an antenna radiator radiating the high frequency signal through the opening part, wherein the high frequency signal is resonated in a specific frequency according to the shape and size of the dielectric resonator 7.

In this case, in order to reduce the return loss at the time of radiating, the feeding unit 5 may further include a plurality of second metal via holes 5d vertically penetrating through the multi-layer substrate 1 so as to connect between the first conductor plate 2 and the second ground plate 5c by forming the vertical metal interface along the feeding line 5a.

The plurality of second metal via holes 5d may be further provided, such that the antenna performance may be improved by reducing the return loss at the time of radiating the to high frequency signal from the dielectric resonator 7.

Meanwhile, the dielectric resonator 7 can change the resonant frequency according to the shape and size of the opening part as described above. According to the preferred embodiment of the present invention, the dielectric resonator 7 formed by the rectangular opening part may be formed to have a hexahedral shape.

In this case, the dielectric resonator 7 may increase the bandwidth by increasing a length thereof in a direction (y direction) parallel with the feeding line 5a.

However, the dielectric resonator 7 may adjust to increase the bandwidth by forming at least one multi-resonant generation via hole 6 within the dielectric resonator 7 in the state in which the dielectric resonator 7 is fixed without increasing a y-directional length.

In more detail, the multi-resonance generation via hole 6 is formed within the dielectric resonator 7 to vertically penetrate through the multi-layer substrate 1 so as to adjust the bandwidth by generating the multi-resonance within the dielectric resonator 7.

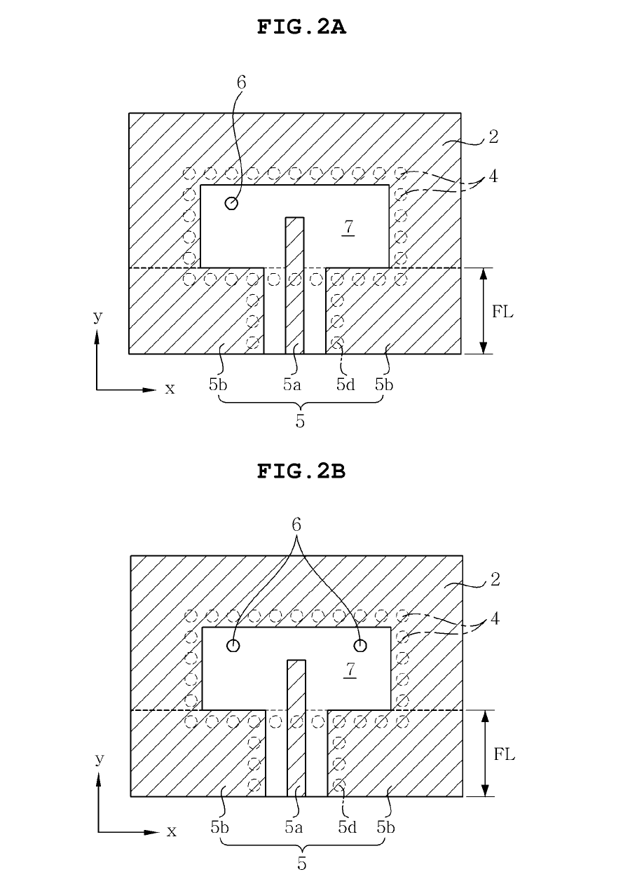

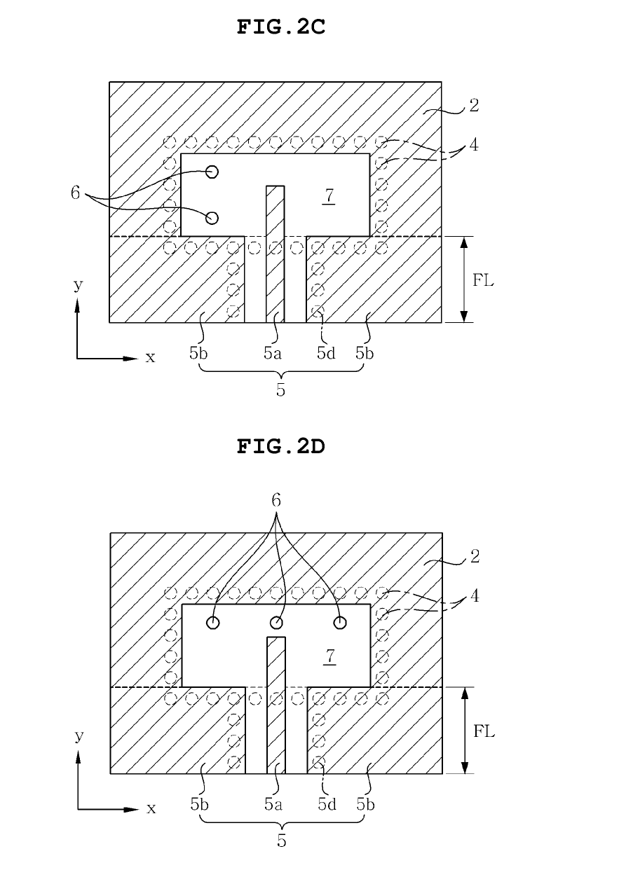

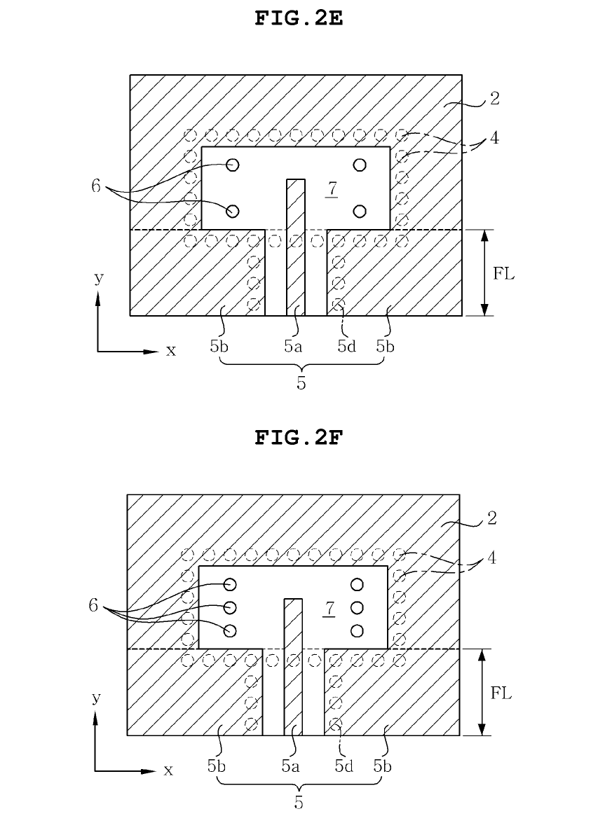

The multi-resonance generation via hole 6 generates various multi-resonances according to the number, position, and length, or the like, thereof. The multi-resonance characteristics in various cases will be described in detail with reference to FIGS. 2A to 7C.

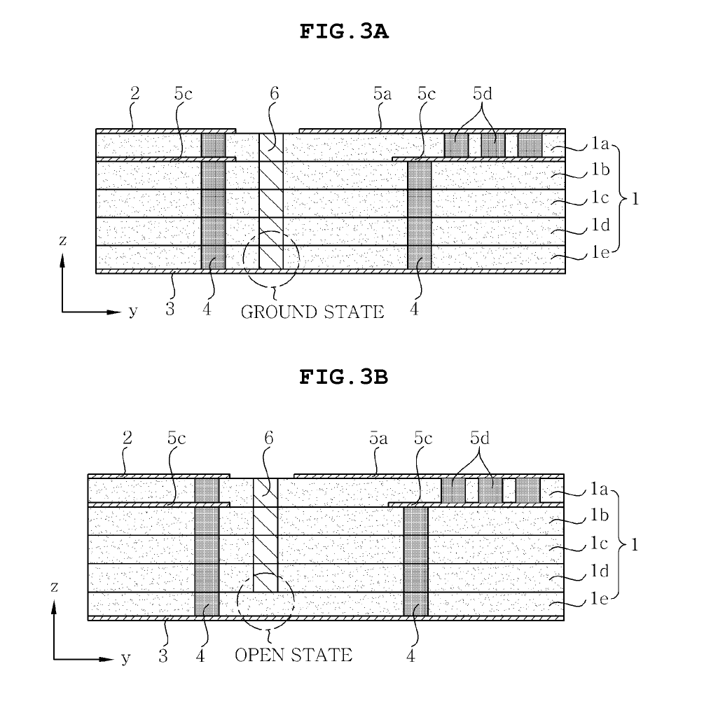

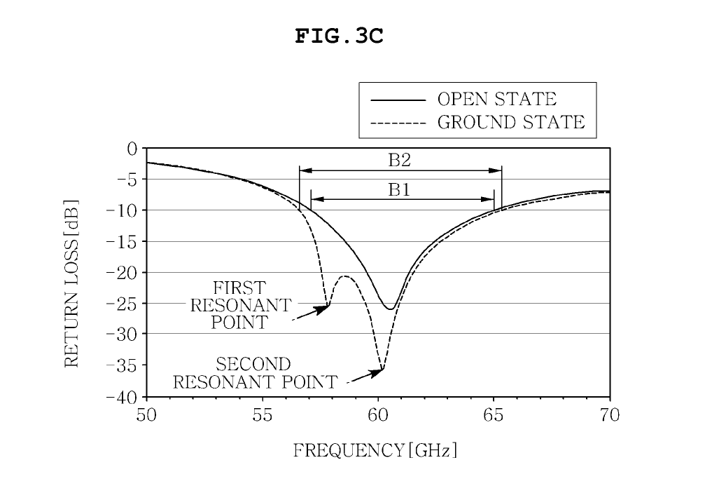

FIGS. 2A to 2F are diagrams showing multi-resonant generation via holes variously formed according to the preferred embodiment of the present invention and FIGS. 3A to 3C are diagrams for describing multi-resonant generation characteristics according to a ground or open state of multi-resonant generation via holes according to the preferred embodiment of the present invention.

As shown in FIGS. 2A to 2F, at least one multi-resonant generation via hole 6 may be formed within the dielectric resonator 7 and has multi-resonant points changed according to the number, position, length, or the like, thereof and therefore, may adjust the frequency bandwidth to be used using the multi-resonance generated by adjusting the number, the position, the length, or the like.

In this case, the position of the multi-resonant generation via hole 6 is not limited, but to a distance from the feeding line 5a (in detail, a distance from a matching line (ML) of the feeding line 5a) may be about X14. Where X, is a frequency wavelength within the dielectric resonator.

Further, the multi-resonant generation via hole 6 needs to be grounded with the second conductor plate 3 as shown in FIG. 3A to generate the multi-resonance having first and second resonant points as shown in FIG. 3C (see a dotted line of FIG. 3C).

As shown in FIG. 3b, when the multi-resonant generation via hole 6 and the second conductor plate 3 are opened, single resonance rather than the multi-resonance is generated (see a solid line of FIG. 3C) as shown in FIG. 3C.

As described above, comparing the return loss graph according to the frequency in the case of the single resonance (solid line) and in the case of the multi-resonance (dotted line), it can be appreciated that a bandwidth B2 in the case of the multi-resonance is improved to be wider than a bandwidth B1 in the case of the single resonance based on when the return loss is −10 dB (B1<B2).

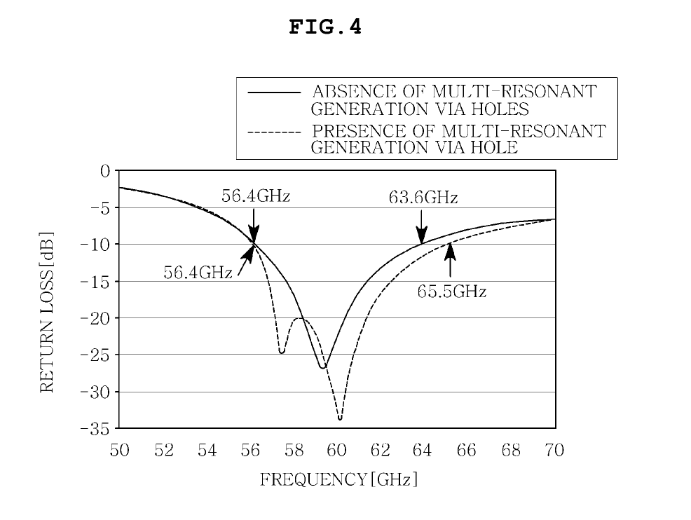

FIG. 4 is a diagram for describing multi-resonant generation characteristics according to presence and absence of the multi-resonant generation via holes according to the preferred embodiment of the present invention.

In detail, FIG. 4 shows graphs of a return loss according to frequencies when the multi-resonant generation via hole 6 according to the preferred embodiment of the present invention is not present (solid line) and is present (dotted line) within the dielectric resonator 7.

As shown in FIG. 4, when the multi-resonant generation via hole 6 is not present in the dielectric resonance 7, the single resonance is generated as shown by a solid line. On the other hand, when the multi-resonant generation via hole 6 is present within the dielectric resonator 7, it can be appreciated that the multi-resonance having two resonant points are generated as shown by a dotted line.

That is, the bandwidth in the single resonance is about 56.4 GHz to 63.6 GHz, while to the bandwidth in the multi-resonance is 56.4 GHz to 65.5 GHz. From this, it can be appreciated that the bandwidth is improved to be wider in the case of the multi-resonance.

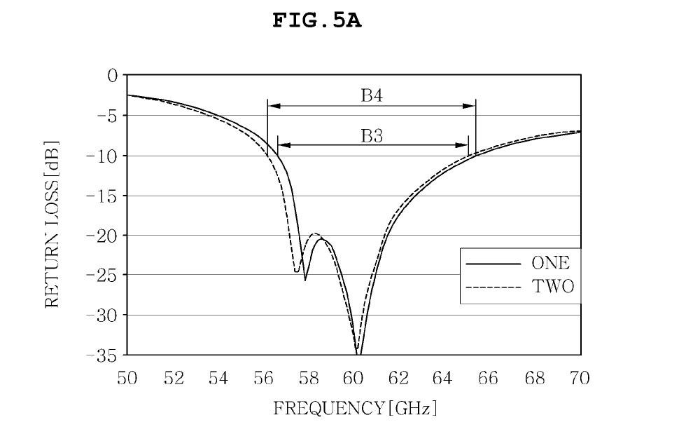

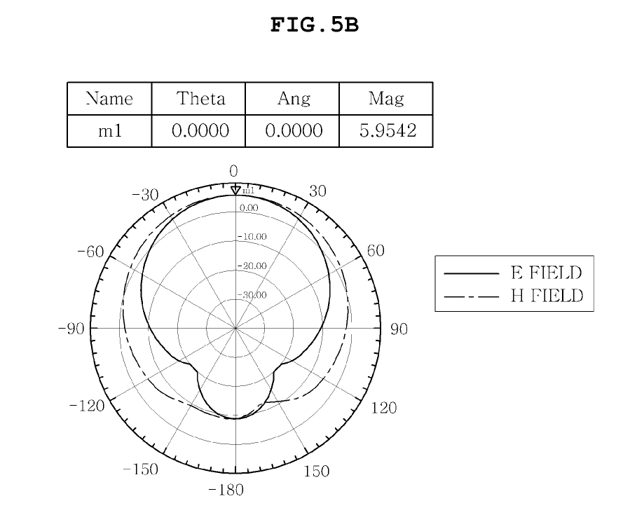

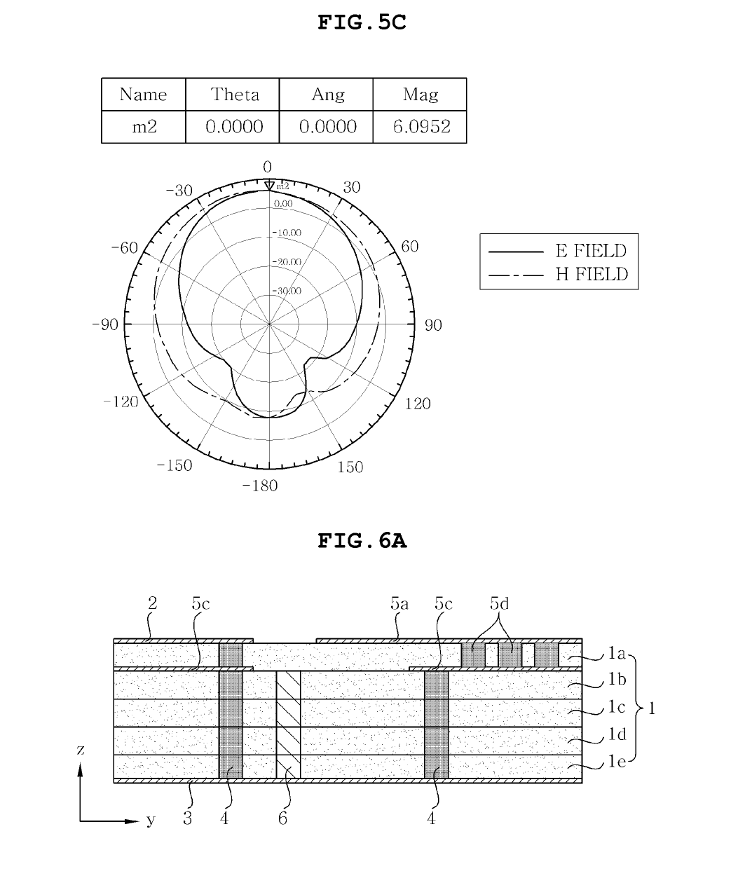

FIGS. 5A to 5C are diagrams for describing the multi-resonant generation characteristics according to the number of multi-resonant generation via holes according to the preferred embodiment of the present invention.

In detail, FIG. 5A shows the graphs of the return loss according to the frequencies when the number of multi-resonant generation via holes 6 is one as shown in FIG. 2A and when the number of multi-resonant generation via holes 6 is two as shown in FIG. 2B, respectively, and FIGS. 5B and 5C show the radiation pattern when the number of multi-resonant generation via holes 6 is one and two, respectively.

As shown in FIG. 5A, it can be appreciated that the bandwidth B4 when the number of multi-resonant generation via holes 6 is two is improved to be wider than the bandwidth B3 when the number of multi-resonant generation via holes 6 is one (B3<B4), based on when the return loss is −10 dB.

In addition, as shown in FIGS. 5B and 5C, comparing the radiation pattern according to the number of multi-resonant generation via holes 6, it can be appreciated that a gain (Mag=6.0952) when the number of multi-resonant generation via holes 6 is two is more excellent than a gain (Mag=5.9542) when the number of multi-resonant generation via holes 6 is one.

As described above, the bandwidth to be used may be adjusted by adjusting the multi-resonant points by adjusting the number of multi-resonant generation via holes 6.

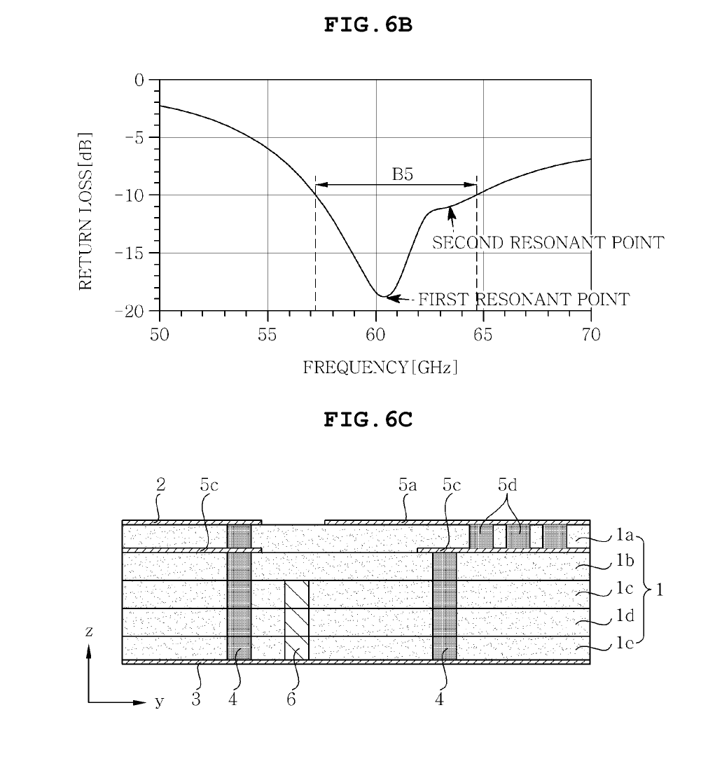

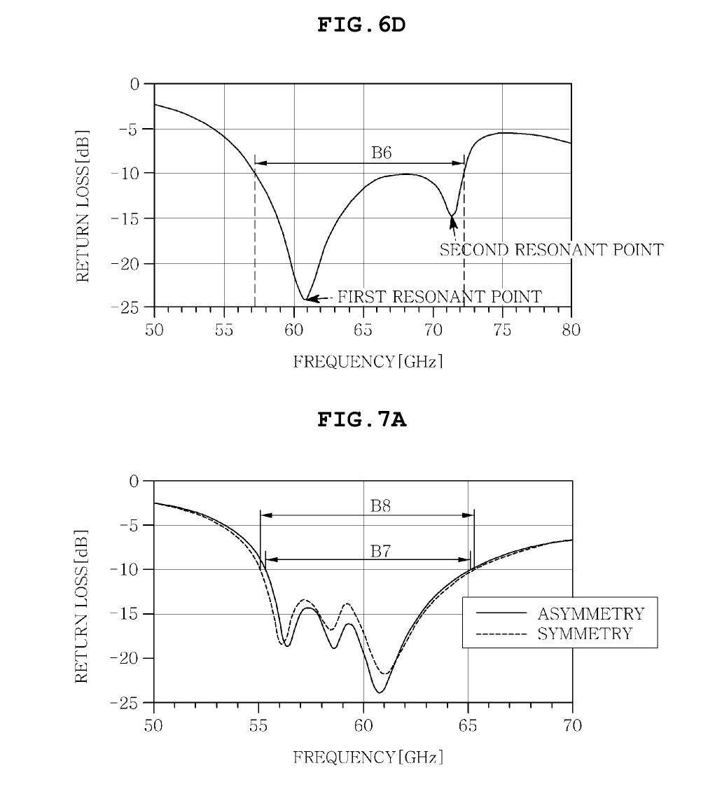

FIGS. 6A to 6D are diagrams for describing the multi-resonant generation characteristics according to a length of the multi-resonant generation via hole according to the preferred embodiment of the present invention.

In detail, FIG. 6A shows a relatively long multi-resonant generation via hole 6 (formed in the second to fifth insulating layers 1b to 1e), FIG. 6B shows a graph of the return loss according to the frequency by the multi-resonance generation via hole 6 shown in FIG. 6A, FIG. 6C shows a relatively short multi-resonant generation via hole 6 (formed in the third to fifth insulating layers 1c to 1e), and FIG. 6D shows the graph of the return loss according to the frequency by the multi-resonant generation via hole 6 shown in FIG. 6C.

As shown in FIG. 6C, when the length of the multi-resonant generation via hole 6 is relatively long, the first resonant point is generated at about 60.5 GHz and the second resonant point is generated at about 63.4 GHz.

However, as shown in FIG. 6D, when the length of the multi-resonant generation via hole 6 is relatively short, the first resonant point is generated at about 61 GHz and the second resonant point is generated at about 71. 6 GHz.

Comparing FIGS. 6C and 6D, it can be appreciated that the first resonant point is little changed, but the change in the second resonant point has a distinctive difference.

That is, it can be appreciated that as the multi-resonant generation via hole 6 becomes short, the second resonant point moves to the high frequency band (moves to the right).

When comparing the movement of the second resonant point based on when the return loss is −10 dB, it can be appreciated that the bandwidth B6 when the length of the multi-resonant generation via hole 6 is relatively short is improved to be wider than a bandwidth B5 when the length of the multi-resonant generation via hole 6 is relatively long (B5<B6).

As described above, the bandwidth to be used may be adjusted by adjusting the multi-resonant point (in particular, the adjustment by moving the second resonant point) by adjusting the length of the multi-resonant generation via hole 6.

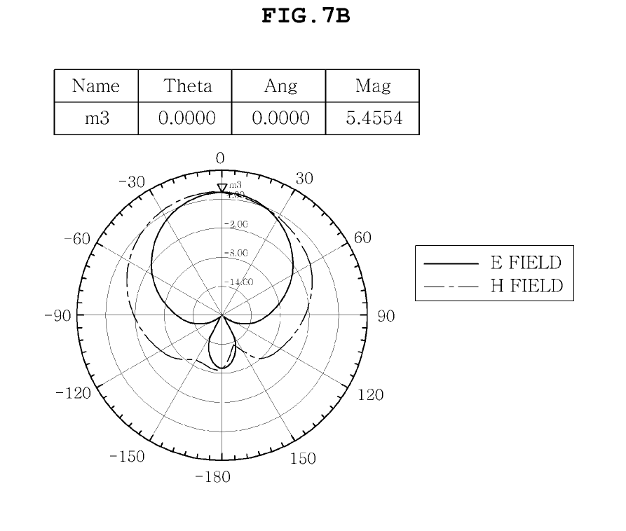

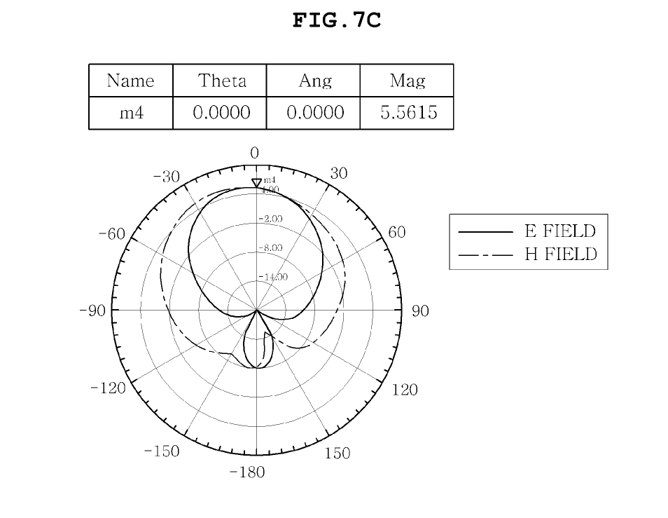

FIGS. 7A to 7C are diagrams for describing the multi-resonant generation characteristics according to a position of the multi-resonant generation via hole according to the embodiment of the present invention.

In detail, FIG. 7A shows the graph of the return loss according to the frequencies when the position of the multi-resonant generation via hole 6 is asymmetrical (solid line) and symmetrical (dotted line) based on the feeding line 5a as shown in FIGS. 2C and 2E, respectively, FIG. 7B shows the radiation pattern when the position of the multi-resonant generation via hole 6 is asymmetrical based on the feeding line 5a, and FIG. 7C shows the radiation pattern when the position of the multi-resonant generation via hole 6 is symmetrical based on the feeding line 5a.

As shown in FIG. 7A, comparing with when the return loss is −10 dB, it can be appreciated that the bandwidth B8 when the position of the multi-resonant generation via hole 6 is symmetrical is improved to be wider than the bandwidth B7 when the position of the multi-resonant generation via hole 6 is asymmetrical (B7<B8), based on the feeding line 5a.

In addition, as shown in FIGS. 7B and 7C, comparing the radiation pattern according to the position of the multi-resonant generation via hole 6, it can be appreciated that the gain (Mag=5.5615) when the position of multi-resonant generation via hole 6 is symmetrical is more excellent than the gain (Mag=5.4554) when the position of multi-resonant generation via hole 6 is asymmetrical based on the feeding line 5a.

As described above, the bandwidth to be used may be adjusted by adjusting the multi-resonant points by adjusting the position of multi-resonant generation via hole 6.

As described above, the bandwidth adjustable dielectric resonant antenna according to the preferred embodiment of the present invention may improve the bandwidth by generating the multi-resonance without adjusting the size of the dielectric resonator 7 by forming at least one multi-resonant generation via hole 6 within the dielectric resonator 7 embedded in the multi-layer substrate.

Further, when the same frequency bandwidth is used, the preferred embodiment of the present invention can reduce the size of the dielectric resonator 7 to implement the miniaturization

As set forth above, the preferred embodiments of the present invention can improve the bandwidth and implement the miniaturization by generating the multi-resonance by at least one multi-resonant generation via hole formed in the dielectric resonator without changing the size of the dielectric resonator embedded in the multi-layer substrate.

Although the preferred embodiments of the present invention have been disclosed for to illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A bandwidth adjustable dielectric resonant antenna, comprising:
a multi-layer substrate on which a plurality of insulating layers are multilayered;
a first conductor plate formed on a top portion of an uppermost insulating layer of the multi-layer substrate to have an opening part thereon;
a second conductor plate formed on a bottom portion of a lowermost insulating layer of the multi-layer substrate to correspond to the opening part;
a plurality of metal vial holes electrically connecting between respective layers of the multi-layer substrate multilayered between the first and second conductor plates and vertically penetrating through the multi-layer substrate so as to form a vertical metal interface while surrounding a circumference of the opening part of the first conductor plate at a predetermined interval;
a feeding unit including a feeding line supplying power to the dielectric resonator embedded in the multi-layer substrate in the cavity shape by the metal interface formed by the first conductor plate, the second conductor plate, and the plurality of metal via holes; and
at least one multi-resonant generation via holes formed within the dielectric resonator by vertically penetrating through the multi-layer substrate so as to adjust the bandwidth by generating the multi-resonance within the dielectric resonator.

2. The bandwidth adjustable dielectric resonant antenna as set forth in claim 1, wherein the dielectric resonator is formed to have a hexahedral shape.

3. The bandwidth adjustable dielectric resonant antenna as set forth in claim 1, wherein the insulating layer is a low temperature co-fired ceramic (LTCC) dielectric or an organic dielectric.

4. The bandwidth adjustable dielectric resonant antenna as set forth in claim 3, wherein the organic dielectric is FR4.

5. The bandwidth adjustable dielectric resonant antenna as set forth in claim 1, wherein a distance between at least one multi-resonant generation via hole and the feeding line is X14, where X, is a frequency wavelength within the dielectric resonator.

6. The bandwidth adjustable dielectric resonant antenna as set forth in claim 1, wherein at least one multi-resonant generation via hole is grounded with the second conductor plate.

7. The bandwidth adjustable dielectric resonant antenna as set forth in claim 1, wherein as the number of at least one multi-resonant generation via hole increases, the bandwidth is improved correspondingly.

8. The bandwidth adjustable dielectric resonant antenna as set forth in claim 1, wherein as the length of at least one multi-resonant generation via hole becomes short, the bandwidth is improved correspondingly.

9. The bandwidth adjustable dielectric resonant antenna as set forth in claim 1, wherein as the position of at least one multi-resonant generation via hole is symmetrical based on the feeding line, the bandwidth is improved correspondingly.

10. The bandwidth adjustable dielectric resonant antenna as set forth in claim 1, wherein the feeding unit includes:
a feeding line formed of the conductor plate in a line shape that extends so as to be inserted into the dielectric resonator from one surface of the dielectric resonator, with being horizontal with the opening part of the dielectric resonator;
a first ground plate disposed so as to correspond to the feeding line and formed on any one of the same layer as the layer formed with the feeding line and the top portion of the insulating layer multilayered above at least one layer or more from the feeding line; and
a second ground plate disposed to correspond to the feeding line and formed on the bottom portion of the insulating layer multilayered below at least one layer or more from the feeding line.

11. The bandwidth adjustable dielectric resonant antenna as set forth in claim 10, wherein the feeding unit further includes a plurality of second metal via holes vertically penetrating through the multi-layer substrate so as to connect between the first conductor plate and the second ground plate by forming the vertical metal interface along the feeding line.

12. The bandwidth adjustable dielectric resonant antenna as set forth in claim 10, wherein the feeding line is formed between the top portion of the uppermost insulating layer and the top portion of the lowermost insulating layer.

13. The bandwidth adjustable dielectric resonant antenna as set forth in claim 10, wherein the feeding line is any one of a strip line, a micro strip line, and a coplanar waveguide (CPW) line.

14. The bandwidth adjustable dielectric resonant antenna as set forth in claim 10, wherein the first ground plate is formed to be integrated with the first conductor plate.
